(19) United States
(12) Patent Application Publication
(10) Pub. No.: US 2010/0066549 A1
(43) Pub. Date: Mar. 18, 2010

(54) Warning device for a gas cylinder

(76) Inventor: Kao Hsung Tsung, Taipei City (TW)

Correspondence Address: BACON & THOMAS, PLLC, 625 SLATERS LANE, FOURTH FLOOR, ALEXANDRIA, VA, 22314-1176, US

(21) Appl. No.: 12/232,275

(22) Filed: Sep. 15, 2008

(51) Int. Cl. G08B 21/00

(52) U.S. Cl. 340/626; 340/611

(57) ABSTRACT

A warning device for a gas cylinder, it is provided on a gas pressure gauge at least with a dial, a needle pointer and a pointer switch; the pressure gauge is connected to an electric power supply and a warning unit; when the amount of the combustion gas is reduced, the needle pointer activates the pointer switch to turn on the warning unit, thus the warning unit emits a warning to remind a user to change the gas cylinder because of exhaustion of combustion gas, thus the bothersome work of inspecting the remaining gas amount by looking at a gas pressure gauge time after time can be saved, and an effect of convenience of using can be provided.

### BACKGROUND OF THE INVENTION

1. Field of the Invention

The present invention relates to a warning device for a gas cylinder, and especially to a pressure gauge having a warning effect.

2. Description of the Prior Art

A combustion device such as a general water heater for bathing or a cooking stove normally uses a gas cylinder for providing combustion gas, the structure of the gas cylinder or the panel on the combustion device has no function of displaying the amount of the combustion gas remaining though, thereby the situation of not being aware of exhaustion of the combustion gas may often occur, and this may result an embarrassing situation that hot water is cut off when bath is taken just to a half course or cooking is stopped when it is just done to a half course, many people must have encountered with such embarrassing and unpleasant situations.

Thereby, manufacturers in the markets developed pressure gauges to be installed on gas cylinders, these pressure gauges are communicated with the gas sources in the gas cylinders, and the pressures of the remaining gases in the gas cylinders can be measured and the amount of the remaining gases in the gas cylinders can be displayed, thereby the above problem of not being aware of exhaustion of the combustion gases can be solved.

However, in considering the esthetical appearance or safety of ventilation, users generally will not place gas cylinders at manifesting areas, and generally partitions are used to obscure them at corners indoor; otherwise, users place gas cylinders outdoors for ventilation, but people are hard to notice the amount of remaining gas in the gas cylinders shown on the pressure gauges, the problem of the above stated being not aware of exhaustion of the combustion may still exist; and more, although some are trying hard to notice the amount of remaining gas in the gas cylinders shown on the pressure gauges, looking hard at the gas pressure gauges time after time is more than a quite trouble thing.

In view of this, the inventor of the present invention provides a warning device for a gas cylinder based on his professional experience of years in manufacturing same kind of products; the warning device for the gas cylinder can remind a user to change the gas cylinder in exhaustion of combustion gas, thus the bothersome work of inspecting the remaining gas amount by looking at a gas pressure gauge time after time can be saved, and an effect of convenience of using can be provided.

### SUMMARY OF THE INVENTION

The primary object of the present invention is to provide a warning device for a gas cylinder that can remind a user to change the gas cylinder in exhaustion of combustion gas, thus the bothersome work of inspecting the remaining gas amount by looking at a gas pressure gauge time after time can be saved.

For achieving the above stated object, the warning device for a gas cylinder of the present invention is provided on a gas pressure gauge at least with a dial, a needle pointer and a pointer switch; the pressure gauge is connected to an electric power supply and a warning unit; wherein:

The dial is provided in the pressure gauge, and includes at least a normal storing level zone and a low level zone to show the state of normally supplying or exhausting.

The needle pointer is provided in the pressure gauge, and can be displaced in pursuance of the remaining amount of the combustion gas; when the amount of the combustion gas is reduced to be exhausted, the needle pointer is moved from the normal storing level zone to the low level zone.

The pointer switch is provided in the low level zone, when the needle pointer is moved from the normal storing level zone to the low level zone, the needle will activate the pointer switch; and in practicing, the pointer switch can be a micro switch that must be contacted with the needle, or a magnetic reed switch or a proximity switch etc. that needs not be contacted with the needle.

The warning unit and the electric power supply can be provided in the pressure gauge, and can be electrically connected with each other when the pointer switch is turned on by the needle; hence the electric power supply provides electric power for the warning unit for emitting a warning to remind a user to change the gas cylinder of exhaustion of combustion gas. When in practicing, the warning unit can provide a warning effect by using various volumes of sound, frequencies of sound, colors of light or frequencies of light flashing; while the electric power supply can be a storage battery or a button type battery etc. for power supplying, and can be mounted outside of the pressure gauge for the convenience of battery changing.

And when in practicing, the pressure gauge can be provided on its outside with a manual switch to control turning on/off of the circuit of the warning unit, in order that the warning unit will not give warning when the pressure gauge is detached for changing the gas cylinder.

As compared with the conventional technique, the warning device for a gas cylinder of the present invention can remind a user to change the gas cylinder in exhaustion of combustion gas, thus the bothersome work of inspecting the remaining gas amount by looking at a gas pressure gauge time after time can be saved to thoroughly eliminate the trouble that bath or cooking may be interrupted, and an effect of convenience of using can be achieved.

The present invention will be apparent in its technical measures after reading the detailed description of the preferred embodiment thereof in reference to the accompanying drawings.

### BRIEF DESCRIPTION OF THE DRAWINGS

FIG. 1 is a perspective schematic view showing installation of the present invention on a gas cylinder;

FIG. 2 is a schematic view showing the structure of the present invention;

FIG. 3 is a schematic view showing a needle pointer is in a normal storing level zone;

FIG. 4 is a schematic view showing the needle pointer is in a low level zone;

FIG. 5 is a perspective schematic view showing another embodiment of a warning device of the present invention.

### DETAILED DESCRIPTION OF THE PREFERRED EMBODIMENT

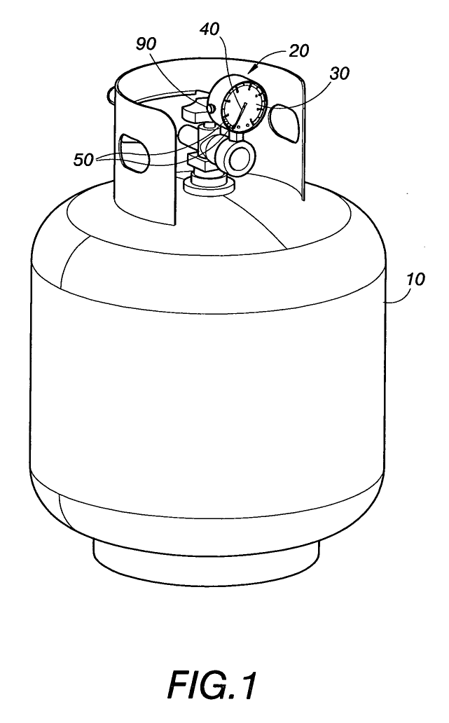

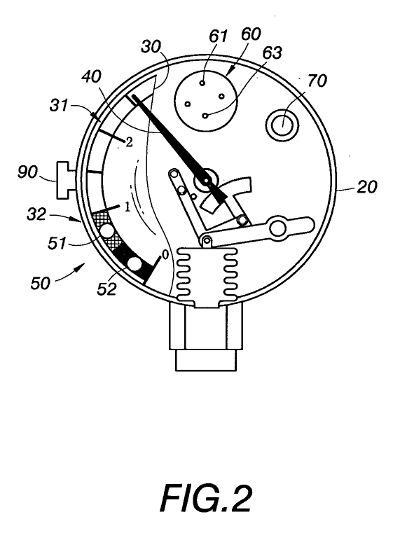

Referring firstly to FIGS. 1 and 2, the warning device for a gas cylinder 10 of the present invention is provided on a gas pressure gauge 20 (in communication with the gas source) of the gas cylinder 10 at least with a dial 30, a needle pointer 40 and a pointer switch 50; the pressure gauge 20 is connected to a warning unit 60 and an electric power supply 70; wherein:

The dial 30 is provided in the pressure gauge 20, and includes at least a normal storing level zone 31 and a low level zone 32 to show the state of normally supplying or exhausting respectively.

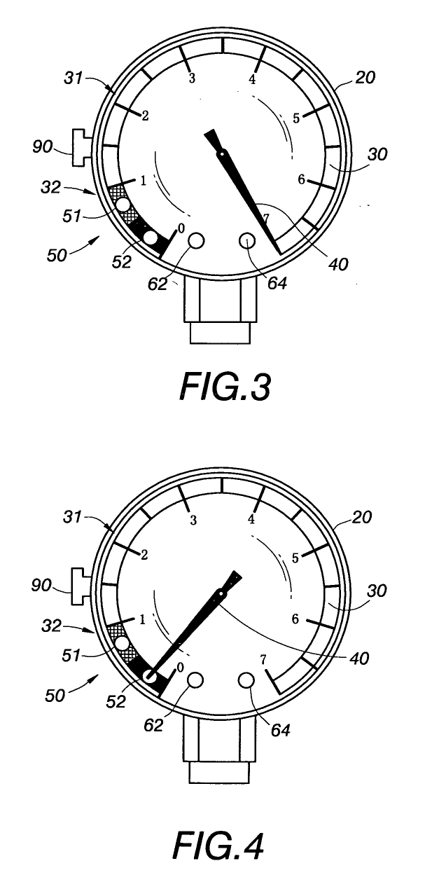

The needle pointer 40 is provided in the pressure gauge 20, and can be displaced in pursuance of the remaining amount of the combustion gas in the gas cylinder 10; when the amount of the combustion gas is reduced to be exhausted, the needle pointer 40 is moved from the normal storing level zone 31 to the low level zone 32, such as are shown in FIGS. 3 and 4.

The pointer switch 50 is provided in the low level zone 32 of the dial 30, or on an inner surface of the pressure gauge 20 and at an area in opposition to the low level zone 32; when the needle pointer 40 is moved from the normal storing level zone 31 to the low level zone 32, the needle 40 will activate the pointer switch 50; and in practicing, the pointer switch 50 can be a micro switch that must be contacted with the needle 40, or a magnetic reed switch or a proximity switch etc. that need not be contacted with the needle 40.

As shown in FIGS. 2 and 4, the warning unit 60 and the electric power supply 70 can be provided in the pressure gauge 20, and can be electrically connected with each other when the pointer switch 50 is turned on by the needle 40; hence the electric power supply 70 provides electric power for the warning unit 60 for giving a warning to warn a user of exhaustion of combustion gas. When in practicing, the warning unit 60 can be a buzzer or an warning lamp to provide a warning effect by using various volumes of sound, frequencies of sound, colors of light or frequencies of light flashing; while the electric power supply 70 can be a common battery such as a storage battery or a button type battery etc. for power supplying, and can be mounted outside of the pressure gauge 20 for the convenience of battery changing.

And when in practicing, the pointer switch 50 can be provided with a first switch 51 and a second switch 52 used respectively in pursuance of the remaining gas amount, in order to distinguish whether the amount of the gas just enters the low level zone 32 that asks for being ready for changing the gas cylinder 10, or the gas is exhausted that asks for changing the gas cylinder 10 immediately. While the warning unit 60 cooperates with the first switch 51, and is provided with a buzzer 61 that slowly emits sound or a yellow flashing warning lamp 62; and cooperates with the second switch 52, and is provided with a buzzer 63 that hastily emits sound or a red flashing warning lamp 64; thus different warning modes are provided to distinguish the amount of the combustion gas presently.

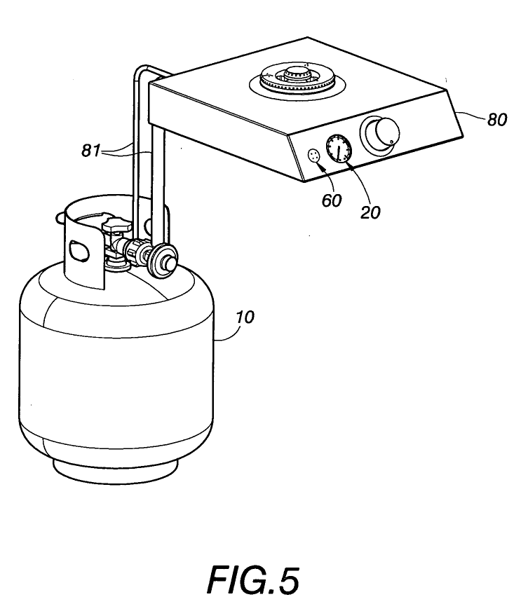

The pressure gauge 20 can be connected with a panel of a burner 80 via a pipe line 81 as shown in FIG. 5; besides, the warning unit 60 can be provided on the panel of the burner 80, alternately, it can be mounted on a wall around the panel of the burner 80; the electric power supply 70 can be a device for generating electricity by itself and without the necessity of changing battery, for instance, it can be a solar energy electric generator or a piezoelectric electric generator.

And more, as shown in FIGS. 1 to 4, the pressure gauge 20 can be provided on its outside with a manual switch 90 to control turning on/off of the circuit of the warning unit 60, in order that the warning unit 60 will not give warning when the pressure gauge 20 is detached for changing the gas cylinder 10.

With the above structure, when the gas cylinder 10 is empty or is changed, the manual switch 90 is turned off in the first place to prevent the alarming of the warning unit 60, then the pressure gauge 20 is installed onto a new gas cylinder 10 fully filled with gas, and then the manual switch 90 is turned on and can be used under inspection; when the combustion gas stored in the gas cylinder 10 is reduced and the needle pointer 40 is moved to the low level zone 32, the needle pointer 40 can thus turn on the pointer switch 50 to activate the circuit of the warning unit 60; by providing different volumes of sound, frequencies of sound, colors of light or frequencies of light flashing, a user can be reminded to change the gas cylinder 10 immediately without the trouble that bath or cooking may be interrupted when being done to a half course, and an effect of convenience of using can be achieved.

The embodiment stated above and depicted is only for illustrating the present invention, and not for giving any limitation to the scope of the present invention. It will be apparent to those skilled in this art that various equivalent modifications or changes without departing from the spirit of this invention shall also fall within the scope of the appended claims.

1. A warning device for a gas cylinder, said warning device is provided on a gas pressure gauge at least with a dial, a needle pointer and a pointer switch; said pressure gauge is connected to an electric power supply and a warning unit; wherein:
said needle pointer is provided in said pressure gauge, and is displaced in pursuance of remaining amount of combustion gas; when amount of said combustion gas is reduced, said needle pointer activates said pointer switch to turn on a circuit of said warning unit, thus said electric power supply provides electric power for said warning unit for emitting a warning.

2. The warning device for a gas cylinder as in claim 1, wherein: said dial includes at least a normal storing level zone and a low level zone, said pointer switch is fixedly provided in said low level zone.

3. The warning device for a gas cylinder as in claim 1, wherein: said dial includes at least a normal storing level zone and a low level zone, said pointer switch is fixedly provided on an inner surface of said pressure gauge and at an area in opposition to said low level zone.

4. The warning device for a gas cylinder as in claim 1, wherein: said warning unit is a buzzer or a warning lamp.

5. The warning device for a gas cylinder as in claim 1, wherein: said pointer switch is provided with a first switch and a second switch used respectively in pursuance of a remaining gas amount.

6. The warning device for a gas cylinder as in claim 5, wherein: said warning unit is provided with a buzzer that slowly emits sound and is controlled by said first switch, and is provided with a buzzer that hastily emits sound and is controlled by said second switch.

7. The warning device for a gas cylinder as in claim 5, wherein: said warning unit is provided with a yellow flashing warning lamp controlled by said first switch, and is provided with a red flashing warning lamp controlled by said second switch.

8. The warning device for a gas cylinder as in claim 1, wherein: said pressure gauge is provided on its outside with a manual switch to control turning on/off of said circuit of said warning unit.

9. The warning device for a gas cylinder as in claim 1, wherein: said warning unit is provided in said pressure gauge.

10. The warning device for a gas cylinder as in claim 1, wherein: said warning unit is provided outside of said pressure gauge.

11. The warning device for a gas cylinder as in claim 1, wherein: said electric power supply is a battery.

12. The warning device for a gas cylinder as in claim 1, wherein: said electric power supply is a solar energy electric generator.
